(19) United States
(12) Patent Application Publication
(10) Pub. No.: US 2014/0008567 A1
(43) Pub. Date: Jan. 9, 2014

(54) CHEMICAL MECHANICAL POLISHING SLURRY

(71) Applicants: Liangyong Wang, Changning District (CN); Zhitang Song, Changning District (CN); Weili Liu, Changning District (CN); Bo Liu, Changning District (CN); Min Zhong, Changning District (CN); Aodong He, Changning District (CN)

(72) Inventors: Liangyong Wang, Changning District (CN); Zhitang Song, Changning District (CN); Weili Liu, Changning District (CN); Bo Liu, Changning District (CN); Min Zhong, Changning District (CN); Aodong He, Changning District (CN)

(21) Appl. No.: 13/202,669

(22) PCT Filed: Jun. 27, 2011
(86) PCT No.: PCT/CN11/76387

§ 371 Date: Aug. 22, 2011

(30) Foreign Application Priority Data
Mar. 24, 2011 (CN) 201110072199

(51) Int. Cl. C09G 1/02

(52) U.S. Cl. CPC C09G 1/02
USPC 252/79.4; 252/79.1

(57) ABSTRACT

A chemical mechanical polishing (CMP) slurry used for phase change memory, characterized by comprising polishing particles, oxidizing agents, chelating agents, inhibiting agents, surface active agents, pH adjusting agents/buffering agents and aqueous medium. Compared with the prior art, the present invention provides a chemical mechanical polishing slurry, by which the controllable selectivity of phase change material/bottom dielectric material (1:1 to 180:1) can be achieved and the phase change properties of phase change materials can be maintained after polishing with the polished surface smooth and free from scratch, meeting process requirements of phase change memory.

### FIELD OF THE INVENTION

This invention relates to a chemical mechanical polishing slurry, and more particularly to a chemical mechanical polishing slurry used for phase change memory.

### BACKGROUND OF THE INVENTION

As consumers have increasingly high data storage requirements, conventional data storage devices have not been able to meet the growing demands of the market and new types of memory devices are coming to the scene, such as, phase change memory, ferroelectric memory, resistive random access memory (RRAM) and etc. Phase change memory (also known as phase change random access memory, PC-RAM), a type of non-volatile semiconductor memories emerging in recent years, is a type of memory devices with low price and stable performance, built on the concept that phase change thin film can be applied to phase change storage medium, which was proposed by Ovshinsky in the late 1960s (Phys. Rev. Lett., 21, 1450˜1453, 1968) and early 1970s (Appl. Phys. Lett., 18, 254˜257, 1971). Phase change memory can be fabricated on silicon wafer substrate, wherein the key materials are recordable phase change material thin films, heating electrode materials, heat-insulating materials, extraction electrode materials and etc. The basic principle of phase change memory is to apply electric pulse signals on device cells to induce reversible phase change between amorphous and polycrystalline states and realize information write, erase and read operations by discerning between the high resistance, amorphous state and low resistance, polycrystalline state.

Compared with various kinds of semiconductor memory technologies of the day, phase change memory has advantages of low power consumption, high density, anti-radiation, non-volatility, high-speed read, high rewritable times (>10¹³ times), device size scalability (nano-scale), high and low temperature resistance (−55° C. to 125° C.), vibration proof, anti-electronic interference and simple process (compatible with current integrated circuit processes). Therefore, it is universally regarded as the most competitive one of the next generation of memories in industry, enjoying extensive market prospect.

PC-RAM utilizes chalcogenide compounds as the storage medium, making use of the significant difference of physical properties between the crystalline and amorphous states to store data. During the fabrication of phase change memory devices, the phase change memory cell structure has been evolved from planar structure to nano confined structure to reduce power consumption and increase storage density. As fabricating nano confined structure, phase change material is usually deposited in nanoholes by chemical vapor deposition; and then, the phase change material above nanoholes is removed by reactive ion etching (RIE) or chemical mechanical polishing (CMP). Compared with RIE process, CMP process can achieve global planarization without introducing dry etching damages and thus has become a key process for the fabrication of phase change memory cells and mass production.

In order to ensure successful implementation of CMP process, a crucial factor, apart from process parameter optimization, is to select suitable polishing slurry. Ideal polishing slurry of CMP process used for phase change memory shall meet the requirements as follow: 1. polishing rate of the phase change material is high enough to ensure high processing efficiency; 2. polishing rate of the bottom dielectric material is low enough (namely, high phase change material to bottom dielectric material polishing selectivity) to ensure enough process window for subsequent processes after polishing; 3. defects on polished wafer surface (e.g., dishing, erosion, scratches and uniformity of layouts with different density) shall be minimized to enhance chip yield; and 4. the phase change material composition will not be changed after polishing to ensure that the properties of phase change material will be kept the same before and after polishing. Since common phase change materials are soft complex alloys of germanium (Ge), antimony (Sb) and tellurium (Te), conventional metal polishing slurry often causes defects such as scratches and residues, and also has low selectivity over bottom dielectric materials or changes phase change properties after polishing, thereby deteriorating device performance and hard to meet CMP process requirements of phase change memory.

### SUMMARY OF THE INVENTION

An object of the present invention is to provide a chemical mechanical polishing slurry so as to solve the problem of device performance deterioration, arising from defects, such as scratches and residues, and low selectivity of bottom dielectric materials or the change of phase change properties after polishing, caused by conventional metal polishing slurry employed currently in CMP process for phase change memory.

The present invention provides a chemical mechanical polishing slurry, comprising polishing particles, oxidizing agents, chelating agents, inhibiting agents, surface active agents, pH adjusting agents/buffering agents and aqueous medium.

Optionally, based on the total weight of chemical mechanical polishing slurry, the content of said polishing particles is 0.1 wt % to 30 wt %, the content of said oxidizing agents is 0.01 wt % to 10 wt %, the content of said chelating agents is 0.01 wt % to 5 wt %, the content of said inhibiting agents is 0.0001 wt % to 5 wt %, and the content of said surface active agents is 0.001 wt % to 2 wt %.

Optionally, the content of said polishing particles is 0.5 wt % to 5 wt %, the content of said oxidizing agents is 0.1 wt % to 5 wt %, the content of said chelating agents is 0.05 wt % to 2 wt %, the content of said inhibiting agents is 0.001 wt % to 1 wt %, and the content of said surface active agents is 0.001 wt % to 1 wt %.

Optionally, said polishing particles are colloidal/fumed SiO₂ with particle diameters in the range of 1 nm to 500 nm.

Optionally, said polishing particles have particle diameters in the range of 10 nm to 150 nm

Optionally, said oxidizing agent is one selected from aqueous hydrogen peroxide, potassium persulfate, ammonium persulfate, iodic acid, periodic acid, potassium iodate, potassium periodate and potassium ferricyanide, or an arbitrary combination thereof.

Optionally, said chelating agent is one selected from ammonium fluoride, acetic acid, ammonium citrate, salicylic acid, cysteine, ammonium chloride, proline, valine, arginine, ammonium oxalate, citric acid, threonine, succinic acid, glycine, ammonium bromide, alanine, formic acid, serine, aminoacetic acid, histidine, tyrosin, ammonium sulfide, cystine, tartaric acid, aspartic acid, threonine, leucine, ethylenediamine tetraacetic acid, isoleucine, terephthalic acid, methionine, urea, glutamic acid, ammonium acetate, tryptophane, ammonium iodide, picolinic acid, gluconic acid, and phenylalanine, or an arbitrary combination thereof.

Optionally, said inhibiting agent is selected from benzotriazole, pyrazole and imidazole.

Optionally, said surface active agent is one selected from fatty alcohol-polyoxyethylene ether, polyacrylic acid, fatty alcohol polyoxyethylene phosphate, tween 80 and hexadecyl trimethyl ammonium bromide, or an arbitrary combination thereof.

Optionally, said pH adjusting agent/buffering agent is one selected from nitric acid, phosphoric acid, sulfuric acid, hydrochloric acid, potassium hydroxide, methylamine, ethylamine, aminoethylethanolamine, dimethylamine, triethylamine, tripropylamine, hexylamine, octylamine and cyclohexylamine, or an arbitrary combination thereof; said pH value is in the range of 1 to 13.

Optionally, said pH value is in the range of 2 to 11.

Optionally, said aqueous medium is deionized water.

Optionally, said chemical mechanical polishing slurry is applied to the chemical mechanical polishing process for chalcogenide phase change memory materials and bottom dielectric materials.

Optionally, general chemical formulae of said chalcogenide phase change memory materials are GeₓSb_{y}Te_{(1-x-y)}, SiₓSb_{y}Te_{(1-x-y)}, SiₘSb₁₀₀₋ₘ, GeₘSb₁₀₀₋ₘ, where, 0≦x≦0.5, 0≦y≦0.5, x and y are not simultaneously zero, and 0<m<100.

Optionally, said bottom dielectric material is one of semiconductor dielectric materials, including silicon nitride, silicon oxide, fluorine-doped silicon oxide, carbon-doped silicon oxide, porous silicon oxide, porous carbon-doped silicon oxide, and polymer.

To sum up, the present invention provides a chemical mechanical polishing slurry used for phase change memory, comprising polishing particles, oxidizing agents, chelating agents, inhibiting agents, surface active agents, pH adjusting agents/buffering agents and aqueous medium. By use of the chemical mechanical polishing slurry provided by the present invention, the controllable selectivity of phase change material/bottom dielectric material (1:1 to 180:1) can be achieved and the phase change properties of phase change materials can be maintained after polishing with the polished surface smooth and free from scratch, meeting process requirements of phase change memory.

### BRIEF DESCRIPTION OF THE DRAWINGS

FIG. 1 is a plot of resistance versus temperature for phase change material Ge₂Sb₂Te₅ before and after polishing with nano cerium dioxide.

FIG. 2 is a plot of resistance versus temperature for phase change material Ge₂Sb₂Te₅ before and after polishing with nano silicon dioxide.

FIG. 3 shows the morphology of phase change material Ge₂Sb₂Te₅ after polishing with tetramethyl ammonium hydroxide as chelating agent.

FIG. 4 shows the morphology of phase change material Ge₂Sb₂Te₅ after polishing with arginine as chelating agent.

FIG. 5 further shows a schematic comparison of removal rates and selectivity of Ge₂Sb₂Te₅ to silicon oxide when a chelating agent is used.

### DETAILED DESCRIPTION OF THE EMBODIMENTS

The inventor of the present invention finds that since phase change materials for phase change memory are normally soft complex alloys of germanium (Ge), antimony (Sb) and tellurium (Te), conventional metal polishing slurry often causes defects such as scratches and residues, and also has low selectivity for bottom dielectric materials or changes phase change properties after polishing, thereby deteriorating device performance and hard to meet CMP process requirements of phase change memory.

Therefore, the inventor of the present invention improves the prior art by providing a novel chemical mechanical polishing slurry, comprising polishing particles, oxidizing agents, chelating agents, inhibiting agents, surface active agents, pH adjusting agents/buffering agents and aqueous medium, by which the controllable selectivity of phase change material/bottom dielectric material (1:1 to 180:1) can be achieved and the phase change properties of phase change materials can be maintained after polishing with the polished surface smooth and free from scratch.

The present invention is further detailed below with reference to the drawings. The present invention provides preferred embodiments, but the embodiments described shall not be interpreted as a limitation. In order to illustrate the structures in a more explicit manner, the thickness of the layer and region is properly magnified in the drawings; however, the schematic drawings shall not be regarded as an exact representation of the geometric proportion. Reference drawings are schematics for the present invention, wherein the illustrations are only on a schematic basis and shall not be construed as a limitation of the scope of the present invention.

The present invention provides a chemical mechanical polishing slurry used in the chemical mechanical polishing process for phase change memory, wherein said phase change memory includes chalcogenide phase change memory materials and bottom dielectric materials, wherein the general chemical formulae of said chalcogenide phase change memory materials are GeₓSb_{y}Te_{(1-x-y)}, SiₓSb_{y}Te_{(1-x-y)}, SiₘSb₁₀₀₋ₘ, GeₘSb₁₀₀₋ₘ, where, 0≦x≦0.5, 0≦y≦0.5, x and y are not simultaneously zero, and 0<m<100, and wherein said bottom dielectric material is one of semiconductor dielectric materials, including silicon nitride, silicon oxide, fluorine-doped silicon oxide, carbon-doped silicon oxide, porous silicon oxide, porous carbon-doped silicon oxide, and polymer.

The present invention provides a chemical mechanical polishing slurry, comprising polishing particles, oxidizing agents, chelating agents, inhibiting agents, surface active agents, pH adjusting agents/buffering agents and aqueous medium.

Each composition is described in detail below:

Polishing particles, by the contact of wafer—polishing particles—polishing pad, can mechanically remove the thin film during the polishing process, wherein said polishing particles are colloidal/fumed SiO₂ with particle diameters in the range of 1 nm to 500 nm, and preferably in the range of 10 nm to 150 nm, and wherein, based on the total weight of chemical mechanical polishing slurry, the content of said polishing particles is 0.1 wt % to 30 wt %, and preferably 0.5 wt % to 5 wt %;

During the polishing process of phase change materials, oxidizing agents are extremely important for the continuous polishing process. As for metal polishing, it is universally recognized that metal is oxidized to form a soft hydrated oxide layer at first, and then the oxidized layer is removed to expose the metal below again. By repeating the aforementioned process, continuous polishing can be achieved. With regard to phase change thin film of GeₓSb_{y}Te_{(1-x-y)}, SiₓSb_{y}Te_{(1-x-y)}, SiₘSb₁₀₀₋ₘ and GeₘSb₁₀₀₋ₘ, Sb and Te have clear metallic properties while Ge and Si have both metallic and non-metallic properties simultaneously. The oxidizing agent of the chemical mechanical polishing slurry provided by the present invention is one selected from aqueous hydrogen peroxide, potassium persulfate, ammonium persulfate, iodic acid, periodic acid, potassium iodate, potassium periodate and potassium ferricyanide, wherein, based on the total weight of chemical mechanical polishing slurry, the content of said oxidizing agent is 0.01 wt % to 10 wt %, and preferably 0.1 wt % to 5 wt %;

By coordination of chelating agents with phase change materials, the removal of oxidized phase change materials is accelerated. The chelating agent of the polishing slurry provided by the present invention is selected from ammonium fluoride, acetic acid, ammonium citrate, salicylic acid, cysteine, ammonium chloride, proline, valine, arginine, ammonium oxalate, citric acid, threonine, succinic acid, glycine, ammonium bromide, alanine, formic acid, serine, aminoacetic acid, histidine, tyrosin, ammonium sulfide, cystine, tartaric acid, aspartic acid, threonine, leucine, ethylenediamine tetraacetic acid (EDTA), isoleucine, terephthalic acid, methionine, urea, glutamic acid, ammonium acetate, tryptophane, ammonium iodide, picolinic acid, gluconic acid, and phenylalanine, wherein, based on the total weight of chemical mechanical polishing slurry, the content of said chelating agent is 0.01 wt % to 5 wt %, and preferably 0.05 wt % to 2 wt %;

By electrostatic attraction, hydrophilic/hydrophobic interaction, hydrogen bonds and etc , inhibiting agents can form a passivation layer on the surface of phase change materials, wherein said passivation layer can well protect the concave surfaces of phase change materials from corrosion caused by chemical compositions of polishing slurry, thereby ensuring device performance and reducing saucer pit defects generated during the polishing process. The inhibiting agent of the polishing slurry provided by the present invention is selected from benzotriazole, pyrazole and imidazole, wherein, based on the total weight of chemical mechanical polishing slurry, the content of said inhibiting agent is 0.0001 wt % to 5 wt %, and preferably 0.001% to 1 wt %.

With specific structures and certain charging properties, surface active agents can improve the stability of the polishing slurry, thereby benefiting the chemical mechanical polishing of phase change materials. The surface active agent of the polishing slurry provided by the present invention is one selected from fatty alcohol-polyoxyethylene ether, polyacrylic acid, fatty alcohol polyoxyethylene phosphate, tween 80 and hexadecyl trimethyl ammonium bromide, or an arbitrary combination thereof, wherein, based on the total weight of chemical mechanical polishing slurry, the content of said surface active agent is 0.001 wt % to 2 wt %, and preferably 0.001% to 1 wt %.

The pH adjusting agents/buffering agents can help stabilize the polishing slurry and further improve polishing performance. The pH adjusting agent/buffering agent of the polishing slurry provided by the present invention is one selected from nitric acid, phosphoric acid, sulfuric acid, hydrochloric acid, potassium hydroxide, methylamine, ethylamine, aminoethylethanolamine, dimethylamine, triethylamine, tripropylamine, hexylamine, octylamine and cyclohexylamine, or an arbitrary combination thereof, wherein said pH value is in the range of 1 to 13, and preferably in the range of 2 to 11.

The aqueous medium of the polishing slurry provided by the present invention is deionized water.

The polishing slurry of the present invention is described below with reference to a specific embodiment.

Now a polishing test is carried out on a phase change thin film material, wherein said phase change thin film material is GeₓSb_{y}Te_{(1-x-y)}, e.g., Ge₂Sb₂Te₅.

For said polishing test,

A. Apparatus: chemical mechanical polishing tester;

B. Conditions:

Down force: 1.5 pounds per square inch (PSI; 1 PSI=6.895 kPa=0.06895 bar);

Pad speed: 75 revolutions per minute (RPM);

Temperature: 25° C.;

Feed rate: 200 ml/min

During polishing testing, Ge₂Sb₂Te₅ is polished with the weight of wafer measured by balance before and after polishing and then calculated to get the removal rate.

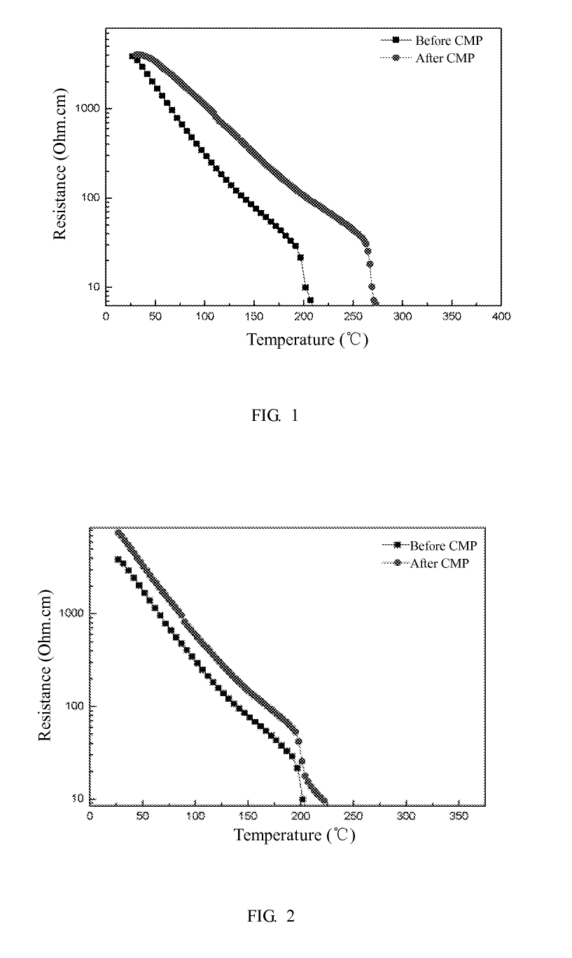

Please refer to FIGS. 1 and 2, which shows the difference of resistance variation with temperature for phase change material Ge₂Sb₂Te₅ when different polishing particles are used, wherein FIG. 1 is a plot of resistance versus temperature for phase change material Ge₂Sb₂Te₅ before and after polishing with nano cerium dioxide, and wherein FIG. 2 is a plot of resistance versus temperature for phase change material Ge₂Sb₂Te₅ before and after polishing with nano silicon dioxide. By comparison of FIGS. 1 and 2, it can be found that, in FIG. 1, when nano cerium dioxide is used for polishing, the plot of resistance versus temperature for phase change material Ge₂Sb₂Te₅ varies greatly before and after polishing, and the temperature at which the resistance abruptly changes drifts obviously after polishing, while, in FIG. 2, when nano silicon dioxide is used for polishing, the plots of resistance versus temperature for phase change material Ge₂Sb₂Te₅ are substantially parallel to each other before and after polishing, and the temperature at which the resistance abruptly changes varies little (both at about 196° C.), thereby ensuring a stable performance of phase change material Ge₂Sb₂Te₅ after polishing.

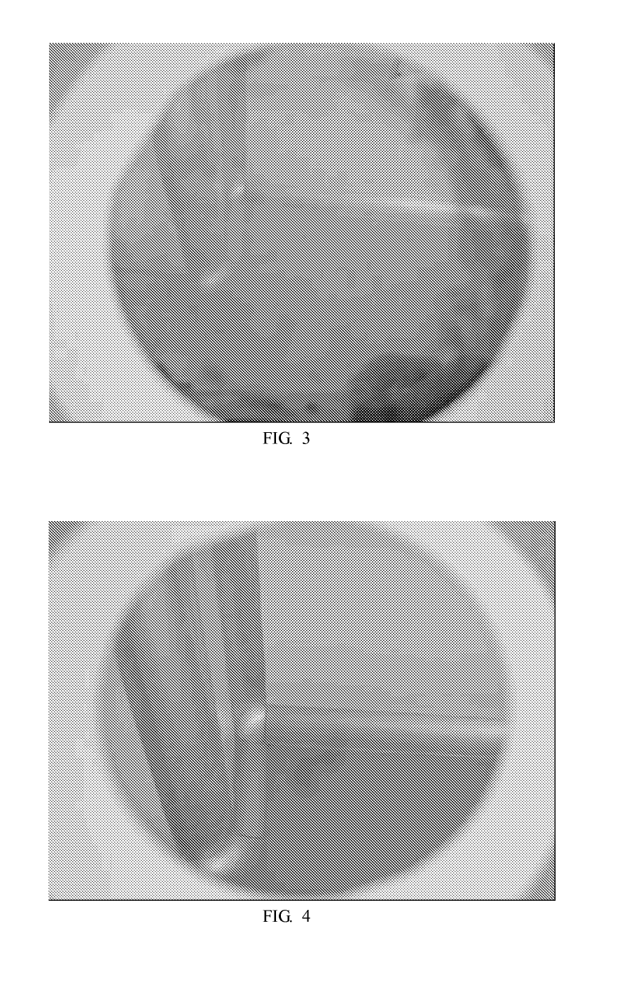

FIGS. 3 and 4 show the difference of the morphology of phase change material Ge₂Sb₂Te₅ after polishing when different chelating agents are used, wherein FIG. 3 shows the morphology of phase change material Ge₂Sb₂Te₅ after polishing with tetramethyl ammonium hydroxide as chelating agent, and wherein FIG. 4 shows the morphology of phase change material Ge₂Sb₂Te₅ after polishing with arginine as chelating agent. By comparison of FIGS. 3 and 4, it can be found that since phase change material Ge₂Sb₂Te₅ is soft, defects such as scratches and corrosions can be generated after polishing, while when the chelating agents such as arginine provided by the present invention is employed, excellent mirror surface can be achieved after polishing with the Ge₂Sb₂Te₅ surface smooth and free from scratches.

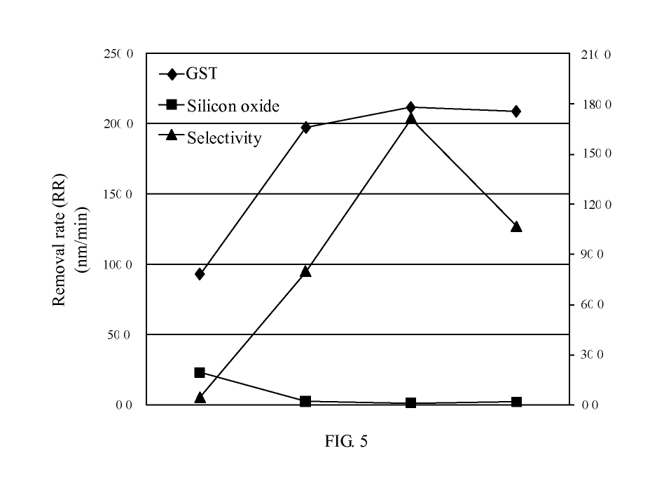

FIG. 5 further shows the removal rates and selectivity of phase change material Ge₂Sb₂Te₅/silicon oxide. As shown in FIG. 5, when the chelating agent of the polishing slurry provided by the present invention is used, the removal rate of phase change material Ge₂Sb₂Te₅ is increased rapidly from about 90 nm/min to about 200 nm/min, greatly enhancing the processing efficiency and throughput of phase change material Ge₂Sb₂Te₅; and at the same time, the removal rate of silicon oxide is strongly decreased from about 20 nm/min to 1˜2 nm/min, thereby the removal selectivity of phase change material Ge₂Sb₂Te₅/silicon oxide is increased up to 180:1. High removal selectivity of Ge₂Sb₂Te₅/silicon oxide and complete decrease of the silicon oxide removal ensure that the CMP process of Ge₂Sb₂Te₅ can be effectively stopped at the bottom dielectric material of silicon oxide, providing enough process window for subsequent processes. It's indicated in FIG. 5 that, by use of the polishing slurry provided by the present invention, the controllable selectivity of phase change material/bottom dielectric material (1:1 to 180:1) can be achieved and the removal rate of Ge₂Sb₂Te₅ under low pressure can still reach as high as 200 nm/min, meeting high throughput requirements of semiconductor manufacturing.

To sum up, the present invention provides a chemical mechanical polishing slurry used for phase change memory, comprising polishing particles, oxidizing agents, chelating agents, inhibiting agents, surface active agents, pH adjusting agents/buffering agents and aqueous medium. By use of the chemical mechanical polishing slurry provided by the present invention, the controllable selectivity of phase change material/bottom dielectric material (1:1 to 180:1) can be achieved and the phase change properties of phase change materials can be maintained after polishing with the polished surface smooth and free from scratch, meeting CMP process requirements of phase change memory.

The description of foregoing embodiment is only an illustrative description of the principle and function of the present invention but is not a limitation of the present invention. It is apparent to those skilled in the art that modifications can be made to the foregoing embodiment without deviating from the spirit and scope of the present invention. Accordingly, the protection scope of the present invention shall be as described in the claims.

What is claimed is:

1. A chemical mechanical polishing slurry used for phase change memory, characterized by comprising polishing particles, oxidizing agents, chelating agents, inhibiting agents, surface active agents, pH adjusting agents/buffering agents and aqueous medium.

2. The chemical mechanical polishing slurry according to claim 1, characterized in that, based on the total weight of chemical mechanical polishing slurry, the content of said polishing particles is 0.1 wt % to 30 wt %, the content of said oxidizing agents is 0.01 wt % to 10 wt %, the content of said chelating agents is 0.01 wt % to 5 wt %, the content of said inhibiting agents is 0.0001 wt % to 5 wt %, and the content of said surface active agents is 0.001 wt % to 2 wt %.

3. The chemical mechanical polishing slurry according to claim 2, characterized in that the content of said polishing particles is 0.5 wt % to 5 wt %, the content of said oxidizing agents is 0.1 wt % to 5 wt %, the content of said chelating agents is 0.05 wt % to 2 wt %, the content of said inhibiting agents is 0.001 wt % to 1 wt %, and the content of said surface active agents is 0.001 wt % to 1 wt %.

4. The chemical mechanical polishing slurry according to claim 1, characterized in that said polishing particles are colloidal/fumed SiO₂ with particle diameters in the range of 1 nm to 500 nm.

5. The chemical mechanical polishing slurry according to claim 4, characterized in that said polishing particles have particle diameters in the range of 10 nm to 150 nm.

6. The chemical mechanical polishing slurry according to claim 1, characterized in that said oxidizing agent is one selected from aqueous hydrogen peroxide, potassium persulfate, ammonium persulfate, iodic acid, periodic acid, potassium iodate, potassium periodate and potassium ferricyanide, or an arbitrary combination thereof.

7. The chemical mechanical polishing slurry according to claim 1, characterized in that said chelating agent is one selected from ammonium fluoride, acetic acid, ammonium citrate, salicylic acid, cysteine, ammonium chloride, proline, valine, arginine, ammonium oxalate, citric acid, threonine, succinic acid, glycine, ammonium bromide, alanine, formic acid, serine, aminoacetic acid, histidine, tyrosin, ammonium sulfide, cystine, tartaric acid, aspartic acid, threonine, leucine, ethylenediamine tetraacetic acid, isoleucine, terephthalic acid, methionine, urea, glutamic acid, ammonium acetate, tryptophane, ammonium iodide, picolinic acid, gluconic acid, and phenylalanine, or an arbitrary combination thereof.

8. The chemical mechanical polishing slurry according to claim 1, characterized in that said inhibiting agent is selected from benzotriazole, pyrazole and imidazole.

9. The chemical mechanical polishing slurry according to claim 1, characterized in that said surface active agent is one selected from fatty alcohol-polyoxyethylene ether, polyacrylic acid, fatty alcohol polyoxyethylene phosphate, tween 80 and hexadecyl trimethyl ammonium bromide, or an arbitrary combination thereof.

10. The chemical mechanical polishing slurry according to claim 1, characterized in that said pH adjusting agent/buffering agent is one selected from nitric acid, phosphoric acid, sulfuric acid, hydrochloric acid, potassium hydroxide, methylamine, ethylamine, aminoethylethanolamine, dimethylamine, triethylamine, tripropylamine, hexylamine, octylamine and cyclohexylamine, or an arbitrary combination thereof; said pH value is in the range of 1 to 13.

11. The chemical mechanical polishing slurry according to claim 10, characterized by said pH value is in the range of 2 to 11.

12. The chemical mechanical polishing slurry according to claim 1, characterized in that said aqueous medium is deionized water.

13. The chemical mechanical polishing slurry according to claim 1, characterized in that said chemical mechanical polishing slurry is applied to the chemical mechanical polishing process for chalcogenide phase change memory materials and bottom dielectric materials.

14. The chemical mechanical polishing slurry according to claim 13, characterized in that general chemical formulae of said chalcogenide phase change memory materials are GeₓSb_{y}Te_{(1-x-y)}, SiₓSb_{y}Te_{(1-x-y)}, SiₘSb₁₀₀₋ₘ, GeₘSb₁₀₀₋ₘ, where, 0≦x≦0.5, 0≦y≦0.5, x and y are not simultaneously zero, and 0<m<100.

15. The chemical mechanical polishing slurry according to claim 13, characterized in that said bottom dielectric material is one of semiconductor dielectric materials, including silicon nitride, silicon oxide, fluorine-doped silicon oxide, carbon-doped silicon oxide, porous silicon oxide, porous carbon-doped silicon oxide, and polymer.
